(19) United States
(12) Patent Application Publication
(10) Pub. No.: US 2017/0163705 A1
(43) Pub. Date: Jun. 8, 2017

(54) METHOD AND ELECTRONIC DEVICE FOR IMPLEMENTING SEAMLESSLY CONTINUOUS PLAYING OF VIDEO

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Fei WANG, Beijing (CN); Rui ZHANG, Beijing (CN)

(21) Appl. No.: 15/245,023

(22) Filed: Aug. 23, 2016

Related U.S. Application Data
(63) Continuation of application No. PCT/CN2016/088935, filed on Jul. 6, 2016.

(30) Foreign Application Priority Data
Dec. 4, 2015 (CN) 201510883895.2

(51) Int. Cl. H04L 29/06; H04L 12/861; H04L 12/26

(52) U.S. Cl. CPC H04L 65/602; H04L 43/16; H04L 49/90

(57) ABSTRACT

Systems and methods for implementing seamlessly continuous playing of video are disclosed. According to implementations herein, a buffering process of a video file may be monitored during playing of the video file. In an exemplary embodiment, a playing address of a next video file to be played is acquired according to a play list when it is monitored that the buffering process is completed, and the next video file to be played is buffered according to the playing address. Further, it may be determined whether a code stream loses or overflows in buffering the next video file to be played, and according to such determination, either the code stream is reduced or increased and the next video file to be played is buffered continuously according to the code stream processed, or the next video file to be played is buffered continuously according to the original code stream.

### CROSS-REFERENCE TO RELATED APPLICATIONS

This application is a continuation of International PCT patent application No. PCT/CN2016/088935 filed on Jul. 6, 2016 (attached hereto as an Appendix), and claims priority to Chinese Patent Application No. 201510883895.2, entitled “METHOD AND SYSTEM FOR IMPLEMENTING SEAMLESSLY CONTINUOUS PLAYING OF VIDEO”, filed on Dec. 4, 2015 with the State Intellectual Property Office of China, all of which are incorporated herein by reference in entirety.

### BACKGROUND

Technical Field

The present disclosure relates to the technical field of media communication, and in particular, to a method and electronic device for implementing seamlessly continuous playing of video.

Description of Related Information

With the rapid development of network technology, the demands of people for the network are reflected in every aspect of life, which begins to have a profound impact on society. With the development of multimedia technology, viewing videos are more and more widely used.

Currently, there are a variety of video application platforms to provide video services for a user in the online video industry. No matter on which video application platform, when viewing a video file, the user often needs to wait for a long period of time to be able to play a next video file after the playing of the video file is finished. That is, the user needs to wait for a long period of time before really starting to view the video file, which causes poor experience of the user in viewing video.

### Overview of Some Aspects

In view of above, an advantage of the disclosure is to provide a method and system for implementing seamlessly continuous playing of video, which solves the problem that the user need to wait for a long period of time to play the next video file after the playing of a video file is finished on a video application platform.

According to a first aspect of embodiments of the present disclosure, there is provided a method for implementing seamlessly continuous playing of video, which includes:

monitoring a buffering process of a video file during playing of the video file;

acquiring a playing address of a next video file to be played according to a play list when it is monitored that the buffering process of the video file is completed, and buffering the next video file to be played according to the playing address; and

determining whether a code stream loses or overflows in buffering the next video file to be played, and according to a determination result, if the code stream loses or overflows, reducing or increasing the code stream and continuing to buffer the next video file to be played according to the code stream processed, or if the code stream does not lose or overflow, continuing to buffer the next video file to be played according to the code stream.

According to a second aspect of embodiments of the present disclosure, there is provided a non-transitory computer-readable storage medium storing executable instructions that, when executed by an electronic device , cause the electronic device to perform any one of the above methods for implementing seamlessly continuous playing of video.

According to a third aspect of embodiments of the present disclosure, there is provided an electronic device including one or more processors and a memory, wherein, the memory is stored with instructions executable by the one or more processors, and the instructions are executed by the one or more processors to cause the one or more processors to perform any one of the above methods for implementing seamlessly continuous playing of video.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart of a method for implementing seamlessly continuous playing of video according to an embodiment of the present disclosure;

FIG. 2 is a schematic flowchart of a method for implementing seamlessly continuous playing of video according to an embodiment of the present disclosure; and

FIG. 3 is a schematic structural diagram of a system for implementing seamlessly continuous playing of video according to an embodiment of the present disclosure;

FIG. 4 is a schematic structure diagram of hardware of an electronic device for implementing seamlessly continuous playing of video according to an embodiment of the disclosure.

### DETAILED DESCRIPTION OF ILLUSTRATIVE IMPLEMENTATIONS

Here the exemplary embodiments are described in details, examples of which are illustrated in the accompanying drawings. When the following description refers to the accompanying drawings, the same numerals in different figures denote the same or similar elements, unless otherwise indicated. The following exemplary embodiments described do not represent all embodiments being consistent with the present disclosure. Rather, they are only examples of apparatus and methods consistent with some aspects of the present disclosure as detailed in the appended claims.

In order to make the objects, technical solutions and advantages of the present disclosure more clear and apparent, the present disclosure is described below in details in conjunction with specific embodiments with reference to the drawings.

According to the application situation of multimedia platforms, before viewing a new video file after the playing of a video file is finished, the user needs to wait for a period of time to normally play the next video file. Therefore, a large amount of time is wasted on waiting to play the video file, which causes user's aversion in viewing the video and poor experience of the user. In order to solve this problem, the disclosure, from the user perspective, has realized that the user wants to play a new video file immediately after the playing of a video file is finished. Hence, the disclosure is based upon a concept that, no matter whether the playing of the video file is finished, a playing address of a new video file is acquired and the new video file is buffered as long as the buffering process of the video file is completed on the multimedia platform.

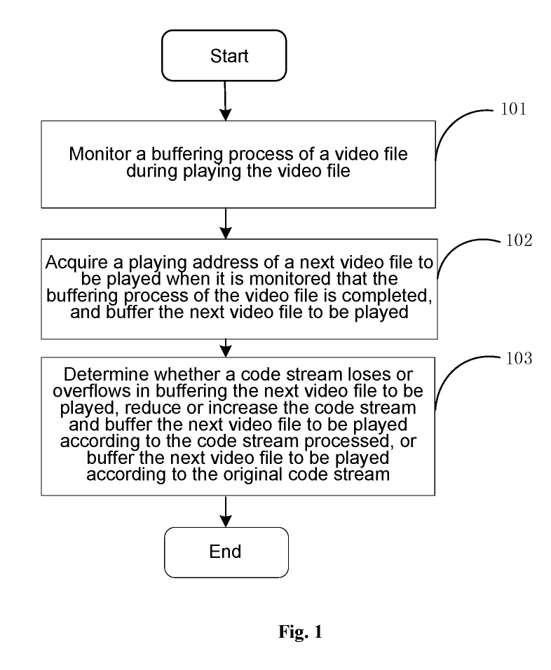

FIG. 1 is a schematic flowchart of a method for implementing seamlessly continuous playing of video according to a first embodiment of the present disclosure. The method includes the following steps.

In step 101, a buffering process of a video file is monitored during playing of the video file.

In the embodiment, the video file is played while a monitoring program is enabled to monitor the buffering process of the video file. A monitoring program may be enabled to monitor a buffering progress of the video file on a progress bar of a video playing page.

In step 102, a playing address of a next video file to be played is acquired according to a play list when it is monitored that the buffering process of the video file is completed, and the next video file to be played is buffered according to the playing address.

In the embodiment, when it is monitored by the monitoring program enabled in step 101 that the buffering process of the video file is completed, the playing address of the next video file to be played is acquired according to the play list, and then the next video file to be played is buffered according to the playing address. In other words, the next video file to be played is not buffered until it is monitored that the buffering process of the video file being played is completed. In other words, in the case that the video file being played is ensured to be played smoothly, the next video file to be played is buffered. The video files with continuous numbers may be ordered in the play list.

As an embodiment of the disclosure, when it is monitored that the buffering process of the video file is completed, it is determined whether the next video file to be played exists in the play list. If the next video file to be played exists in the play list, the playing address of the next video file to be played in the play list is acquired, and the next video file to be played is buffered according to the playing address. If the next video file to be played does not exist in the play list, it is prompted that the next video file to be played does not exist and it is determined whether to clear a buffer region after the playing of the video file is finished; if it is determined to clear the buffer region, an operation for clearing the buffer region is performed after the playing of the video file is finished.

It should be noted that, if a loop play is set for the video file being played, the process of acquiring the playing address of the next video file to be played from the play list and buffering the next video file to be played is not performed when it is monitored that the buffering process of the video file is completed.

In addition, a buffering amount of buffering the next video file to be played may be set when the video file being played is not finished. The buffering amount of buffering the next video file to be played is the first 15 seconds in buffering the next video file to be played, which can ensure that the next video file is played directly after the video file being played is finished, and workload of user terminal is reduced, thereby improving work efficiency.

As another embodiment of the disclosure, whether in buffering the video file being played or buffering the next video file to be played, the method may include: determining whether a buffered capacity in the buffer region exceeds a preset threshold; according to a determination result, if the buffered capacity in the buffer region exceeds the preset threshold, deleting the video file buffered which has been played in the buffer region and then continuing to buffer the video file, or if the buffered capacity in the buffer region does not exceed the preset threshold, continuing to buffer the video file. Therefore, it may be ensured that the buffer region does not take up too much space, and the buffering of the video file can be completed, thereby improving the utilization rate of the buffer region.

It should be noted that, when the next video file to be played is buffered, it may be also determined whether the video file being played is set to skip a head leader and a tail leader; if the video file being played is set to skip the head leader and the tail leader, the next video file to be played is buffered from an end of the head leader of the next video file to be played to a start of the tail leader of the next video file to be played, or if the video file being played is not set to skip the head leader and the tail leader, the next video file to be played is directly buffered.

In step 103, it is determined whether a code stream loses or overflows in buffering the next video file to be played, and according to a determination result, if the code stream loses or overflows, the code stream is reduced or increased and the next video file to be played is buffered continuously according to the code stream processed, or if the code stream does not lose or overflow, the next video file to be played is buffered continuously according to the original code stream.

It may be determined whether the code stream loses or overflows in buffering the next video file to be played, and if the code stream loses or overflows, the code stream is reduced or increased and then the video file is buffered continuously according to the reduced or increased code stream. If the code stream does not lose or overflow, the video file is buffered continuously according to the original code stream. Of course, it may be determined whether the code stream loses or overflows in buffering the video file being played, and the process proceeds in the manner discussed above. Therefore, the buffering of the next video file to be played may be adjusted dynamically by the method for implementing seamlessly continuous playing of video, according to the actual network condition.

In another embodiment, in buffering the next video file to be played, it may be determined whether the next video file to be played is played with a code stream to be paid. If the next video file to be played is played with the code stream to be paid, a user level is acquired and it is determined whether the user level matches with the code stream to be paid; and If the user level matches with the code stream to be paid, the next video file to be played is buffered according to the code stream to be paid; or if the user level does not match with the code stream to be paid, the next video file to be played is buffered according to the code stream to be paid in a limited period of time and the next video file to be played is buffered according to a free code stream after the limited period of time. If the next video file to be played is not played with the code stream to be paid, the video file may be buffered directly.

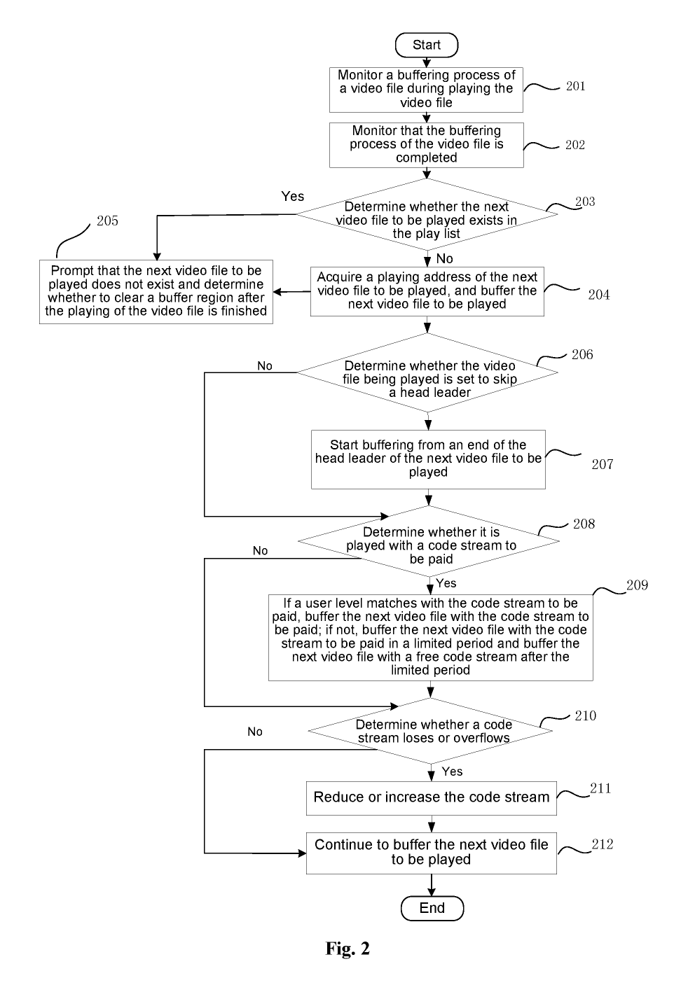

As a referable embodiment, referring to FIG. 2, the method for implementing seamlessly continuous playing of video may include the following steps.

In step 201, a buffering process of a video file is monitored during playing of the video file.

In step 202, it is monitored that the buffering process of the video file is completed.

In step 203, it is determined whether a next video file to be played exists in a play list; if the next video file to be played exists in the play list, step 204 is performed, or if the next video file to be played does not exist in the play list, step 205 is performed.

In step 204, a playing address of the next video file to be played is acquired according to the play list, and the next video file to be played is buffered according to the playing address, and then step 206 is performed.

In step 205, it is prompted that the next video file to be played does not exist and it is determined whether to clear a buffer region after the playing of the video file is finished. If it is determined to clear the buffer region, the buffer region is cleared after the playing of the video file is finished and the method is ended; if it is determined not to clear the buffer region, the method is ended directly.

In step 206, it is determined whether the video file being played is set to skip a head leader. If the video file being played is set to skip the head leader, step 207 is performed; if the video file being played is not set to skip the head leader, step 208 is performed directly.

In step 207, the next video file to be played is buffered from an end of the head leader of the next video file to be played, and then step 208 is performed.

In step 208, it is determined whether the next video file to be played is played with a code stream to be paid. If the next video file to be played is played with the code stream to be paid, step 209 is performed; if the next video file to be played is not played with the code stream to be paid, step 210 is performed directly.

In step 209, a user level is acquired and it is determined whether the user level matches with the code stream to be paid. If the user level matches with the code stream to be paid, the next video file to be played is buffered according to the code stream to be paid; or if the user level does not match with the code stream to be paid, the next video file to be played is buffered according to the code stream to be paid in a limited period of time and the next video file to be played is buffered according to a free code stream after the limited period of time. Then step 210 is performed.

In step 210, it is determined whether a code stream loses or overflows in buffering the next video file to be played. If the code stream loses or overflows in buffering the next video file to be played, step 211 is performed; or if the code stream does not lose or overflow in buffering the next video file to be played, step 212 is performed directly.

In step 211, the code stream is reduced or increased, and then step 212 is performed.

In step 212, the next video file to be played is buffered continuously.

As another referable embodiment, in the process of performing step 210 to step 212, the method may further include: determining whether a buffered capacity in a buffer region exceeds a preset threshold; if the buffered capacity in the buffer region exceeds the preset threshold, deleting the video file buffered which has been played in the buffer region and then continuing to buffer the video file, or if the buffered capacity in the buffer region does not exceed the preset threshold, continuing to buffer the video file.

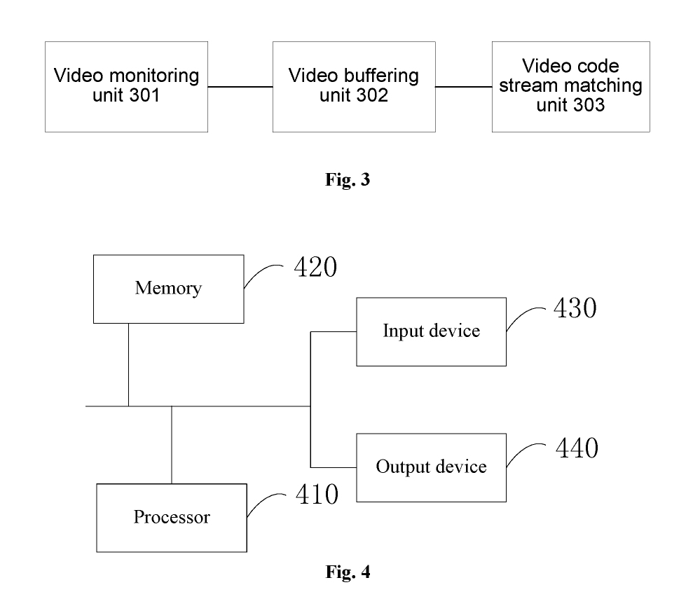

In another aspect of the disclosure, a system for implementing seamlessly continuous playing of video is further provided. As shown in FIG. 3, the system includes a video monitoring unit 301, a video buffering unit 302 and a video code stream matching unit 303 connected in sequence. The video monitoring unit 301 is configured to monitor a buffering process of a video file during playing the video file. The video buffering unit 302 is configured to acquire a playing address of a next video file to be played according to a play list when it is monitored that the buffering process of the video file is completed, and buffer the next video file to be played according to the playing address. The video code stream matching unit 303 is configured to determine whether a code stream loses or overflows in buffering the next video file to be played, and if the code stream loses or overflows, reduce or increase the code stream and continue to buffer the next video file to be played according to the code stream processed, or if the code stream does not lose or overflow, continue to buffer the next video file to be played according to the original code stream.

The video monitoring unit 301 may enable a monitoring program to monitor a buffering progress of the video file on a progress bar of a video playing page, when playing the video file.

As another embodiment of the disclosure, in buffering the next video file to be played, when it is monitored that the buffering process of the video file is completed, the video buffering unit 302 determines whether the next video file to be played exists in the play list. If the next video file to be played exists in the play list, the video buffering unit 302 acquires the playing address of the next video file to be played in the play list and buffers the next video file to be played according to the playing address. If the next video file to be played does not exist in the play list, the video buffering unit 302 prompts that the next video file to be played does not exist and determines whether to clear the buffer region after the playing of the video file is finished. If it is determined to clear the buffer region, the video buffering unit 302 performs an operation for clearing the buffer region after the playing of the video file is finished.

As another referable embodiment, when buffering the next video file to be played, the video buffering unit 302 may further determine whether the video file being played is set to skip a head leader and a tail leader. If the video file being played is set to skip the head leader and the tail leader, the video buffering unit 302 buffers the next video file to be played from an end of the head leader of the next video file to be played to a start of the tail leader of the next video file to be played. If the video file being played is not set to skip the head leader and the tail leader, the video buffering unit 302 directly buffers the next video file to be played.

Whether in buffering the video file being played or buffering the next video file to be played, the video buffering unit 302 may determine whether a buffered capacity in a buffer region exceeds a preset threshold, and if the buffered capacity in the buffer region exceeds the preset threshold, delete the video file buffered which has been played in the buffer region and then continue to buffer the video file, or if the buffered capacity in the buffer region does not exceed the preset threshold, continue to buffer the video file, according to a determination result. Therefore, it may be ensured that the buffer region does not take up too much space, and the buffering of the video file can be completed, thereby improving the utilization rate of the buffer.

In addition, the video code stream matching unit 303 may determine whether a code stream loses or overflows in buffering the next video file to be played. If the code stream loses or overflows, the code stream is reduced or increased and then the video file is buffered continuously according to the code stream reduced or increased. If the code stream does not lose or overflow, the video file is buffered continuously according to the original code stream. Of course, it may be determined whether the code stream loses or overflows in buffering the video file being played, and the process proceeds in the manner discussed above. Therefore, the buffering of the next video file to be played may be adjusted dynamically by the method for implementing seamlessly continuous playing of video, according to the actual network condition.

When the next video file to be played is buffered, the video code stream matching unit 303 may determine whether the next video file to be played is played with a code stream to be paid. If the next video file to be played is played with the code stream to be paid, the video code stream matching unit 303 acquires a user level and determines whether the user level matches with the code stream to be paid. If the user level matches with the code stream to be paid, the next video file to be played is buffered according to the code stream to be paid, or if the user level does not match with the code stream to be paid, the next video file to be played is buffered according to the code stream to be paid in a limited period of time and the next video file to be played is buffered according to a free code stream after the limited period of time. If the next video file to be played is not played with the code stream to be paid, the video file is buffered directly.

It should be noted that, the specific implementation content of the system for implementing seamlessly continuous playing of video according to the present disclosure has been described in detail in the method for implementing seamlessly continuous playing of video described above, thus the content herein is not repeated any more.

Embodiments of the present disclosure further provide a non-volatile computer-readable storage medium, the non-volatile computer-readable storage medium is stored with computer executable instructions which are configured to perform any of the embodiments described above of the method for implementing seamlessly continuous playing of video.

FIG. 4 is a schematic diagram of hardware structure of an electronic device used to perform the method for implementing seamlessly continuous playing of video according to an embodiment of the present disclosure, as shown in FIG. 4, the device includes:

One or more processors 410 and a memory 420, FIG. 4 illustrates one processor 410 as an example.

The device for the method for implementing seamlessly continuous playing of video may further include an input device 430 and an output device 440.

The processor 410, the memory 420, the input device 430 and the output device 440 may be connected with each other through bus or other forms of connections. FIG. 4 illustrates bus connection as an example.

As a non-volatile computer-readable storage medium, the memory 420 may be configured to store non-volatile software program, non-volatile computer executable program and modules, such as program instructions/modules corresponding to the method for implementing seamlessly continuous playing of video according to the embodiments of the disclosure (for example, the obtaining module 100, the adjusting module 200 and the packaging module 300, as illustrated in FIG. 3. By executing the non-volatile software program, instructions and modules stored in the memory 420, the processor 410 may perform various functional applications of the server and data processing, that is, the method for implementing seamlessly continuous playing of video according to the above mentioned embodiments.

The memory 420 may include a program storage area and a data storage area, wherein, the program storage area may be stored with the operating system and applications which are needed by at least one functions, and the data storage area may be stored with data which is created according to use of the device for implementing seamlessly continuous playing of video. Further, the memory 420 may include a high-speed random access memory, and may further include non-volatile memory, such as at least one of disk memory device, flash memory device or other types of non-volatile solid state memory device. In some embodiments, optionally, the memory 420 may include memory provided remotely from the processor 410, and such remote memory may be connected with the device for implementing seamlessly continuous playing of video through network connections, the examples of the network connections may include but not limited to internet, intranet, LAN (Local Area Network), mobile communication network or combinations thereof.

The input device 430 may receive inputted number or character information, and generate key signal input related to the user settings and functional control of the device for implementing seamlessly continuous playing of video. The output device 440 may include a display device such as a display screen.

The above one or more modules may be stored in the memory 420, when these modules are executed by the one or more processors 410, the method for implementing seamlessly continuous playing of video according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console , E-book and smarttoys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for implementing seamlessly continuous playing of a video, which is applied to an electronic device, comprising:
monitoring a buffering process of a video file during playing of the video file;
acquiring a playing address of a next video file to be played according to a play list when it is monitored that the buffering process of the video file is completed, and buffering the next video file to be played according to the playing address; and
determining whether a code stream loses or overflows in buffering the next video file to be played, and according to a determination result, if the code stream loses or overflows, reducing or increasing the code stream and continuing to buffer the next video file to be played according to the code stream processed, or if the code stream does not lose or overflow, continuing to buffer the next video file to be played according to the code stream.

2. The method according to claim 1, wherein, after buffering the next video file to be played, the method further comprises:
if the next video file to be played is played with a code stream to be paid, acquiring a user level and determining whether the user level matches with the code stream to be paid, and if the user level matches with the code stream to be paid, buffering the next video file to be played according to the code stream to be paid, or if the user level does not match with the code stream to be paid, buffering the next video file to be played according to the code stream to be paid in a limited period of time and buffering the next video file to be played according to a free code stream after the limited period of time.

3. The method according to claim 1, wherein, during the buffering process of the video file, the method further comprises:
determining whether a buffered capacity in a buffer region exceeds a preset threshold; and
according to a determination result, if the buffered capacity in the buffer region exceeds the preset threshold, deleting the video file buffered which has been played in the buffer region and then continuing to buffer the video file, or if the buffered capacity in the buffer region does not exceed the preset threshold, continuing to buffer the video file.

4. The method according to claim 3, wherein, the buffering the next video file to be played comprises:
determining whether the video file being played is set to skip a head leader and a tail leader; and
if the video file being played is set to skip the head leader and the tail leader, buffering the next video file to be played from an end of the head leader of the next video file to be played to a start of the tail leader of the next video file to be played, or if the video file being played is not set to skip the head leader and the tail leader, directly buffering the next video file to be played.

5. The method according to claim 3, wherein, when it is monitored that the buffering process of the video file is completed, the method further comprises:
determining whether the next video file to be played exists in the play list; and
according to a determination result, if the next video file to be played exists in the play list, acquiring the playing address of the next video file to be played in the play list, and buffering the next video file to be played according to the playing address, or if the next video file to be played does not exist in the play list, prompting that the next video file to be played does not exist and determining whether to clear the buffer region after the playing of the video file is finished, and if it is determined to clear the buffer region, clearing the buffer region after the playing of the video file is finished and exiting, or if it is determined not to clear the buffer region, directly exiting.

6. A non-transitory computer-readable storage medium storing executable instructions that, when executed by an electronic device , cause the electronic device to:
monitor a buffering process of a video file during playing of the video file;
acquire a playing address of a next video file to be played according to a play list when it is monitored that the buffering process of the video file is completed, and buffer the next video file to be played according to the playing address; and
determine whether a code stream loses or overflows in buffering the next video file to be played, and according to a determination result, if the code stream loses or overflows, reduce or increase the code stream and continue to buffer the next video file to be played according to the code stream processed, or if the code stream does not lose or overflow, continue to buffer the next video file to be played according to the code stream.

7. The non-transitory computer-readable storage medium according to claim 6, wherein, after the next video file to be played is buffered, the electronic device is further caused to:
if the next video file to be played is played with a code stream to be paid, acquire a user level and determine whether the user level matches with the code stream to be paid, and if the user level matches with the code stream to be paid, buffer the next video file to be played according to the code stream to be paid, or if the user level does not match with the code stream to be paid, buffer the next video file to be played according to the code stream to be paid in a limited period of time and buffer the next video file to be played according to a free code stream after the limited period of time.

8. The non-transitory computer-readable storage medium according to claim 6, wherein, during the buffering process of the video file, the electronic device is further caused to:
determine whether a buffered capacity in a buffer region exceeds a preset threshold; and
according to a determination result, if the buffered capacity in the buffer region exceeds the preset threshold, delete the video file buffered which has been played in the buffer region and then continue to buffer the video file, or if the buffered capacity in the buffer region does not exceed the preset threshold, continue to buffer the video file.

9. The non-transitory computer-readable storage medium according to claim 8, wherein, the buffering the next video file to be played comprises:
determining whether the video file being played is set to skip a head leader and a tail leader; and
if the video file being played is set to skip the head leader and the tail leader, buffering the next video file to be played from an end of the head leader of the next video file to be played to a start of the tail leader of the next video file to be played, or if the video file being played is not set to skip the head leader and the tail leader, directly buffering the next video file to be played.

10. The non-transitory computer-readable storage medium according to claim 6, wherein, when it is monitored that the buffering process of the video file is completed, the electronic device is further caused to:
determine whether the next video file to be played exists in the play list; and
according to a determination result, if the next video file to be played exists in the play list, acquire the playing address of the next video file to be played in the play list, and buffer the next video file to be played according to the playing address, or if the next video file to be played does not exist in the play list, prompt that the next video file to be played does not exist and determine whether to clear the buffer region after the playing of the video file is finished, and if it is determined to clear the buffer region, clear the buffer region after the playing of the video file is finished and exit, or if it is determined not to clear the buffer region, directly exit.

11. An electronic device, comprising:
at least one processor; and
a memory communicably connected with the at least one processor,
wherein the memory is stored with instructions executable by the at least one processor, and the instructions are executed by the at least one processor to cause the at least one processor to:
monitor a buffering process of a video file during playing of the video file;
acquire a playing address of a next video file to be played according to a play list when it is monitored that the buffering process of the video file is completed, and buffer the next video file to be played according to the playing address; and
determine whether a code stream loses or overflows in buffering the next video file to be played, and according to a determination result, if the code stream loses or overflows, reduce or increase the code stream and continue to buffer the next video file to be played according to the code stream processed, or if the code stream does not lose or overflow, continue to buffer the next video file to be played according to the code stream.

12. The electronic device according to claim 11, wherein, after the next video file to be played is buffered, the at least one processor is further caused to:
if the next video file to be played is played with a code stream to be paid, acquire a user level and determine whether the user level matches with the code stream to be paid, and if the user level matches with the code stream to be paid, buffer the next video file to be played according to the code stream to be paid, or if the user level does not match with the code stream to be paid, buffer the next video file to be played according to the code stream to be paid in a limited period of time and buffer the next video file to be played according to a free code stream after the limited period of time.

13. The electronic device according to claim 11, wherein, during the buffering process of the video file, the at least one processor is further caused to:
determine whether a buffered capacity in a buffer region exceeds a preset threshold; and
according to a determination result, if the buffered capacity in the buffer region exceeds the preset threshold, delete the video file buffered which has been played in the buffer region and then continue to buffer the video file, or if the buffered capacity in the buffer region does not exceed the preset threshold, continue to buffer the video file.

14. The electronic device according to claim 13, wherein, the buffering the next video file to be played comprises:
determining whether the video file being played is set to skip a head leader and a tail leader; and
if the video file being played is set to skip the head leader and the tail leader, buffering the next video file to be played from an end of the head leader of the next video file to be played to a start of the tail leader of the next video file to be played, or if the video file being played is not set to skip the head leader and the tail leader, directly buffering the next video file to be played.

15. The electronic device according to claim 11, wherein, when it is monitored that the buffering process of the video file is completed, the at least one processor is further caused to:
determine whether the next video file to be played exists in the play list; and
according to a determination result, if the next video file to be played exists in the play list, acquire the playing address of the next video file to be played in the play list, and buffer the next video file to be played according to the playing address, or if the next video file to be played does not exist in the play list, prompt that the next video file to be played does not exist and determine whether to clear the buffer region after the playing of the video file is finished, and if it is determined to clear the buffer region, clear the buffer region after the playing of the video file is finished and exit, or if it is determined not to clear the buffer region, directly exit.

16. The method according to claim 1, wherein, when it is monitored that the buffering process of the video file is completed, the method further comprises:
determining whether the next video file to be played exists in the play list; and
according to a determination result, if the next video file to be played exists in the play list, acquiring the playing address of the next video file to be played in the play list, and buffering the next video file to be played according to the playing address, or if the next video file to be played does not exist in the play list, prompting that the next video file to be played does not exist and determining whether to clear the buffer region after the playing of the video file is finished, and if it is determined to clear the buffer region, clearing the buffer region after the playing of the video file is finished and exiting, or if it is determined not to clear the buffer region, directly exiting.

17. The method according to claim 2, wherein, when it is monitored that the buffering process of the video file is completed, the method further comprises:
determining whether the next video file to be played exists in the play list; and
according to a determination result, if the next video file to be played exists in the play list, acquiring the playing address of the next video file to be played in the play list, and buffering the next video file to be played according to the playing address, or if the next video file to be played does not exist in the play list, prompting that the next video file to be played does not exist and determining whether to clear the buffer region after the playing of the video file is finished, and if it is determined to clear the buffer region, clearing the buffer region after the playing of the video file is finished and exiting, or if it is determined not to clear the buffer region, directly exiting.

18. The method according to claim 2, wherein, during the buffering process of the video file, the method further comprises:
determining whether a buffered capacity in a buffer region exceeds a preset threshold; and
according to a determination result, if the buffered capacity in the buffer region exceeds the preset threshold, deleting the video file buffered which has been played in the buffer region and then continuing to buffer the video file, or if the buffered capacity in the buffer region does not exceed the preset threshold, continuing to buffer the video file.

19. The method according to claim 18, wherein, the buffering the next video file to be played comprises:
determining whether the video file being played is set to skip a head leader and a tail leader; and
if the video file being played is set to skip the head leader and the tail leader, buffering the next video file to be played from an end of the head leader of the next video file to be played to a start of the tail leader of the next video file to be played, or if the video file being played is not set to skip the head leader and the tail leader, directly buffering the next video file to be played.

20. The method according to claim 19, wherein, when it is monitored that the buffering process of the video file is completed, the method further comprises:
determining whether the next video file to be played exists in the play list; and
according to a determination result, if the next video file to be played exists in the play list, acquiring the playing address of the next video file to be played in the play list, and buffering the next video file to be played according to the playing address, or if the next video file to be played does not exist in the play list, prompting that the next video file to be played does not exist and determining whether to clear the buffer region after the playing of the video file is finished, and if it is determined to clear the buffer region, clearing the buffer region after the playing of the video file is finished and exiting, or if it is determined not to clear the buffer region, directly exiting.
